(19) United States
(12) Patent Application Publication
(10) Pub. No.: US 2010/0088885 A1
(43) Pub. Date: Apr. 15, 2010

(54) Method and apparatus for isolating battery terminals from corrosive elements

(76) Inventor: Michael Stephen Evanbar, Downey, CA (US)

Correspondence Address: Michael Stephen Evanbar, #29, 8132 Firestone Blvd., Downey, CA, 90241, US

(21) Appl. No.: 12/317,325

(22) Filed: Dec. 23, 2008

Related U.S. Application Data
(60) Provisional application No. 61/195,693, filed on Oct. 9, 2008.

(51) Int. Cl. H01M 2/32

(52) U.S. Cl. 29/623.2; 29/730

(57) ABSTRACT

A method and apparatus have been developed to precisely position and distribute an adhesive sealant for the purpose of blocking corrosion paths to electrically conducting surfaces on battery terminals. In order to achieve this objective, the present invention makes use of a rectangular-shaped, sealant-packed laminate with a battery post cut-out that is wrapped around and bonded to the terminal by the user at the work site or, alternatively, by the terminal fabricator for first-time use. In either case, corrosion path gateways are blocked on both top and bottom sides of the terminal's post-hole aperture by the act of seating a thusly wrapped terminal on the battery post and depressing the terminal against the battery plane before tightening the securing bolt. Seating the seal-wrapped terminal thusly positions sealant around the battery post base, effectively denying corrosive elements an entrance to electrically-conducting surfaces.

### RELATED APPLICATIONS

The present application is a continuation application of United States provisional patent application, Ser. No. 61/195,693, filed Oct. 9, 2008, for A PRE-FORMED ELASTOMERIC ADHESIVE SEALANT DEVICE FOR TERMINALS, by Michael Stephen Evanbar, included by reference herein and for which benefit of the priority date is hereby claimed.

The present application is related to U.S. Pat. No. 4,752,545, issued Jun. 21, 1988, by Brecht, et al, included by reference herein.

The present application is related to U.S. Pat. No. 4,683,647, issued Aug. 4, 1987, by Brecht, et al, included by reference herein.

### FIELD OF THE INVENTION

The present invention relates to a method and apparatus to control battery post and battery terminal corrosion and, more particularly, to a method to precisely position an adhesive sealant on and around corrosion gateways to electrically-conducting surfaces on terminals.

### BACKGROUND OF THE INVENTION

The main problem with conventional battery powered systems relates to endemic battery deficiencies in the state-of-the art, specifically the impact of lead-acid battery electrolyte leakage on battery terminal corrosion throughout the charge/discharge life cycle. In such batteries, leakage of the electrolyte from the battery case (acid gassing) around a battery post extending through the case will, over time, degrade the capability of the battery and corrode battery terminals, adjacent battery mounts and cabling systems. In addition to acid gassing corrosion, these accumulated deposits on battery terminals, left unchecked, will provide ‘short to ground’ paths to drain stored energy. Battery terminal and post acid gassing deposits are the leading cause of “hard starting” for automotive battery systems. To forestall this condition typically requires significant maintenance hours over the life of the battery.

A provisional patent No. 61/195,693 detailing a device and method of use for resolving the problem stated above was filed on Oct. 9, 2008 with the USPTO. The invention described herein is intended as a continuation application of the device and methods detailed in the provisional application.

It can be appreciated that battery terminal corrosion prevention and corrosion removal devices have been in use for years. Typically, corrosion prevention devices are chemical in nature, such as grease, lubricants and chemical ‘pads’ placed on the battery post. Other types of battery terminal protection devices currently in use consist of loose fitting rubber “boots”, primarily designed to protect against accidental short-circuits. In addition to these few ‘preventative’ devices, most products currently on the market are devoted to simplifying the removal of corrosion from the battery posts and terminals. Yet another approach was presented by Brecht, et al, U.S. Pat. Nos. 4,683,647 and 4,752,545, Aug. 4, 1987 and Jun. 21, 1988, respectively, which describes a device for sealing a lead-acid battery using an apertured cover with the aperture being for passage of a terminal post. The intended purpose of the Brecht, et al device solely was to prevent leakage of the electrolyte from within the battery to outside the battery; i.e., the device is not intended to protect battery functionality from corrosive environments outside the battery.

The main problem with conventional battery corrosion prevention devices intended to enhance battery performance is that they are only effective for a limited amount of time, and thus require periodic replacement to continuously block the effects of acid gassing, corrosion, moisture, dirt, and other contaminants that can provide ‘short to ground’ paths and drain the capability of stored energy power sources. Another problem with convention battery terminal corrosion protection devices is that they are function specific and do not address the need to protect battery function from a multiplicity of threats such as accidental short-to-ground, conductive surface contamination and corrosion of adjacent metal components. Also, because conventional battery corrosion prevention devices do not function effectively for the life of the battery itself, they do not obviate the need for periodic replacement and servicing; i.e., labor-intensive periodic removal, cleaning, and remounting of the terminals on the battery posts. Another problem with conventional battery corrosion prevention devices is that they do not effectively address endemic battery deficiencies in the state-of-the art, specifically the impact of lead-acid battery electrolyte leakage on the battery charge/discharge life cycle. Leakage of the electrolyte from the battery case (acid gassing) will not only degrade the capability of the battery but will corrode adjacent metal structures. The use of conventional ‘chemical blockers’ are not 100% effective in controlling acid gassing and even with routine replacement only partially block the deleterious effect of acid gassing on battery performance.

It also may be presumed that applying a protective coating to the battery terminal will retard the accumulation of corrosion products on the outer surface of the battery terminal; however, battery terminal coating will not retard the accumulation of deposits on the electrically-conductive surfaces of the battery post and terminal, and thus, must be assumed a cosmetic treatment at best.

It would be advantageous to provide a means whereby a user, without tools and specific learned skills, can easily apply a corrosion inhibiting device at the work site that will function effectively and continuously throughout the life cycle of the battery.

It also would be advantageous to provide a sealant device for application to battery terminals that will have the capability to be removed by untrained users at the worksite without tools.

In addition, It would be advantageous to provide battery terminal corrosion prevention functionality with the capability to accommodate a large range of terminal types and sizes.

In addition, It would be advantageous to provide a corrosion prevention device and method for application to battery terminals that can inhibit the accumulation of corrosive deposits on surrounding metal parts such as battery frame, cables and connectors.

Additionally, It would be advantageous to provide a corrosion prevention device and method for application to battery terminals that will reduce the maintenance labor and time inherent to conventional battery maintenance art.

Additionally, It would be advantageous to provide an adhesive sealant device for application to battery terminals that can address the endemic deficiencies in current ‘lead acid’ battery art such as electrolyte leakage or acid fumes on loss of charge and battery performance throughout multiple battery charge and discharge cycles.

### SUMMARY OF THE INVENTION

In accordance with the present invention, there is provided a sealant delivery apparatus and method for use with battery terminals that will block corrosion gateways to electrically conducting surfaces from the deleterious effects of electrolytic leakage and other corrosive elements. In order to achieve this objective, the present invention makes use of a specifically-shaped, flexible, sealant-layered laminate with a post-hole cut-out. The laminate is wrapped around the terminal by the user and bonded to the terminal by means of a pressure-sensitive adhesive sealant. The pressure-sensitive adhesive sealant layer is protected until use by a removable liner which is stripped away by the user before deployment. The adhesive sealant can be any elastomeric adhesive sealant such as a fully-cured butyl or equivalent that exhibits the characteristics required by the present sealant delivery device to function effectively, including the capability of the sealant to deform and assume compliant shapes under pressure. Delivery of the sealant to block specifically targeted corrosion gateways is accomplished by the act of seating the battery terminal fitted with the sealant device on the battery post. The user depresses the terminal against the battery plane prior to tightening the retaining bolt, displacing the sealant through the post-hole cutout to form around the battery post base. The upper corrosion pathways to the terminal through the battery post aperture is also blocked by seating the terminal fitted with the sealant device back on the battery post, due to the fact that the seal extends axially along the top of the terminal and over the battery post.

### BRIEF DESCRIPTION OF THE DRAWINGS

A complete understanding of the present invention may be obtained by reference to the accompanying drawings, when considered in conjunction with the subsequent, detailed description, in which:

FIG. 1 depicts top and side views of the pre-shaped flexible seal laminate illustrating the laminate's geometry and outer layer bonded to the pressure-sensitive adhesive sealant;

FIG. 2 is a perspective view of the deployment preparation method, including laminate trimming to fit short terminals and removal of any pre-existing corrosion and contamination on terminals prior to deploying the sealant;

FIG. 3 is a perspective view of a seal being positioned, aligned, deployed and tacked to upper and lower terminal surfaces;

FIG. 4 is a perspective view of the process for securing the seal to the terminal by stretching, overlapping and bonding the seal's side flaps to the terminal;

FIG. 5 is a top perspective view of the terminal seating process on the battery post wherein the terminal, with seal installed, is compressed against the battery plane;

FIG. 6 comprises perspective views of the seal seating and sealant delivery detail. The expanded view of FIG. 6 depicts the mechanics of targeting sealant delivery to the terminal corrosion gateway where the battery post penetrates the battery case;

FIG. 7 is a perspective view of the corrosion seal device and method applied to a ‘marine-type’ battery terminal; and

FIG. 8 is a perspective view of an alternate factory-bonded terminal seal shown being fitted to a conventional automotive ‘straight type’ battery terminal.

For purposes of clarity and brevity, like elements and components will bear the same designations and numbering throughout the Figures.

### DESCRIPTION OF THE PREFERRED EMBODIMENT

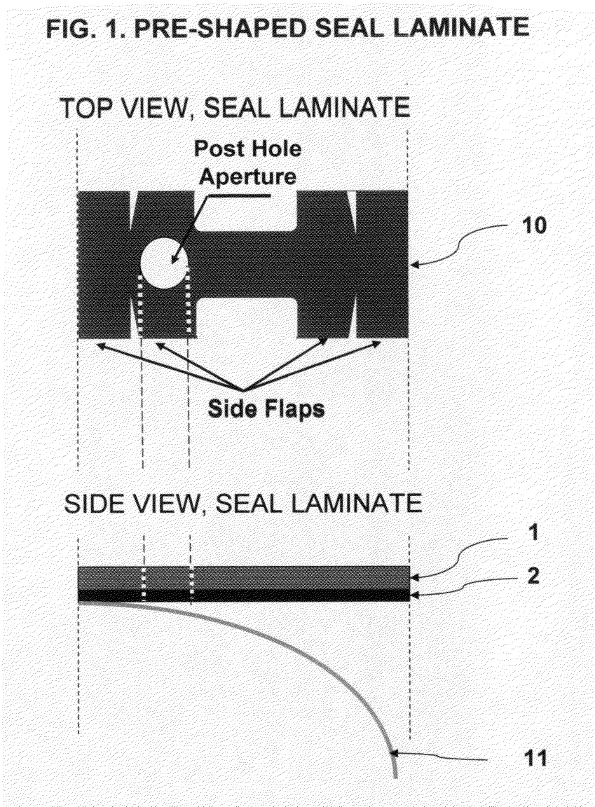

The battery terminal corrosion seal 10 is comprised of a moldable seal outer layer 1 backed with the adhesive sealant 2 and having a post-hole aperture cut through the seal laminate. When the seal laminate is wrapped around the battery terminal, the aperture provides for passage of the battery post through the terminal when seating the terminal on the battery. The seal laminate device to be installed at the work site by the user is a rectangular shaped elastomeric, pre-cut to specific template designs to fit a variety of standard terminal sizes and shapes. The seal outer layer 1 may be comprised of a material such as uncured Ethylene-Propylene-Diene Monomer (EDPM) synthetic rubber or an equivalent material other than EDPM rubber. However, the material should not be electrically conductive. The seal laminate thickness will range between 60 and 90 mils (thousands of an inch) for most applications, although thicker and/or thinner materials may be used effectively for special-purpose applications. FIG. 1 is a detailed view of the components defining the user-installed seal laminate. The top view of FIG. 1 illustrates the pre-shaped flexible laminate geometry that provides a terminal-universal wrap-around form to fit multiple battery terminal types. FIG. 1 also illustrates the battery post aperture cut-out. The FIG. 1 side view shows the inner layer of adhesive sealant 2 bonded to the seal outer layer 1. The FIG. 1 side view also depicts the removable sealant protective liner element 11 that maintains the integrity of the adhesive sealant 2 during storage and prior to use, for the user-installed device.

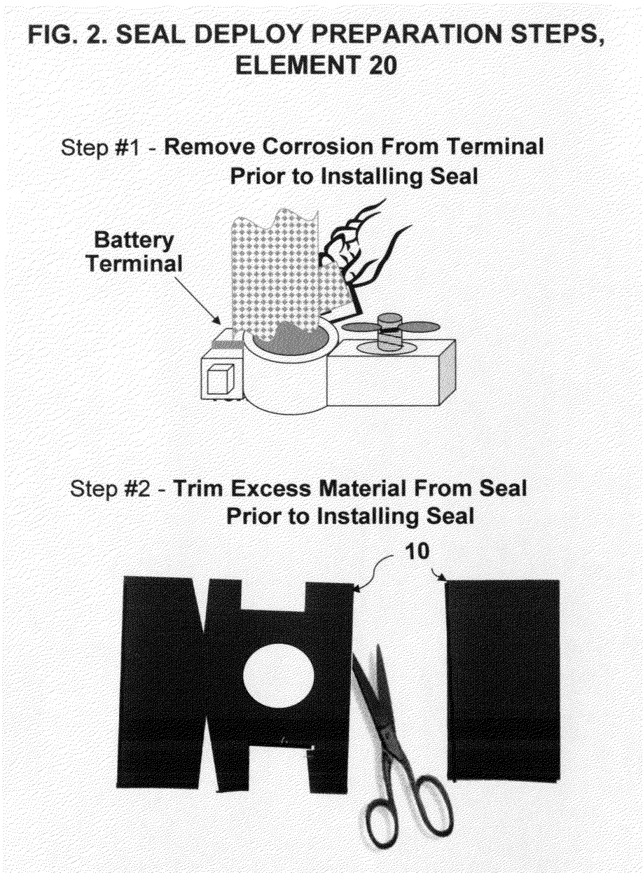

The user-installed device deploy preparation element 20 includes the steps that the user must complete before deploying the seal to the terminal, as well as the steps required to insure a permanent bond to terminal corrosion gateway areas. FIG. 2 illustrates these deployment preparation steps, including removal of protective liner and any pre-existing corrosion and contamination on the terminal prior to deploying the device. FIG. 2 also illustrates the seal laminate trimming step necessary for the device to fit terminals with wing nuts, shortened or side terminals, and prior to deploying the seal. Pre-deployment preparation insures that the user-installed sealant device will fit the terminal and bond securely to the battery terminal surfaces.

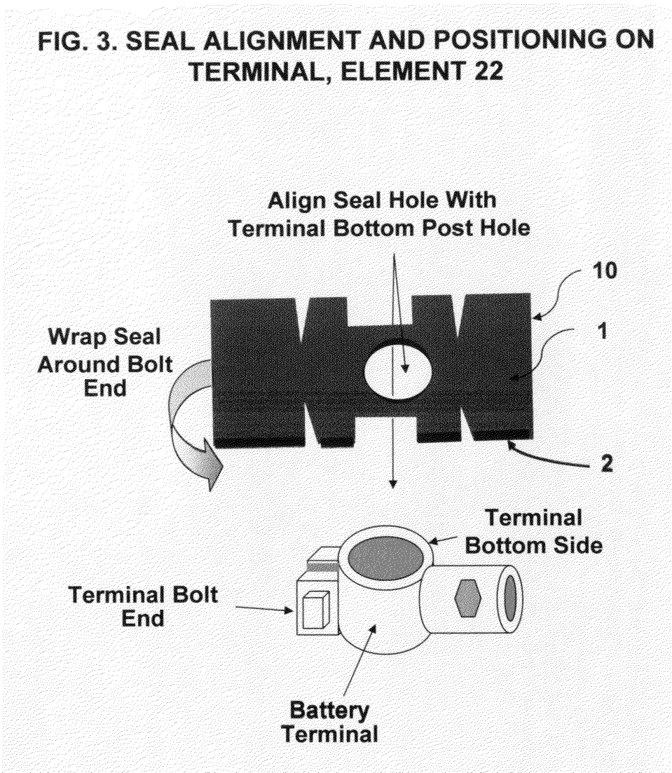

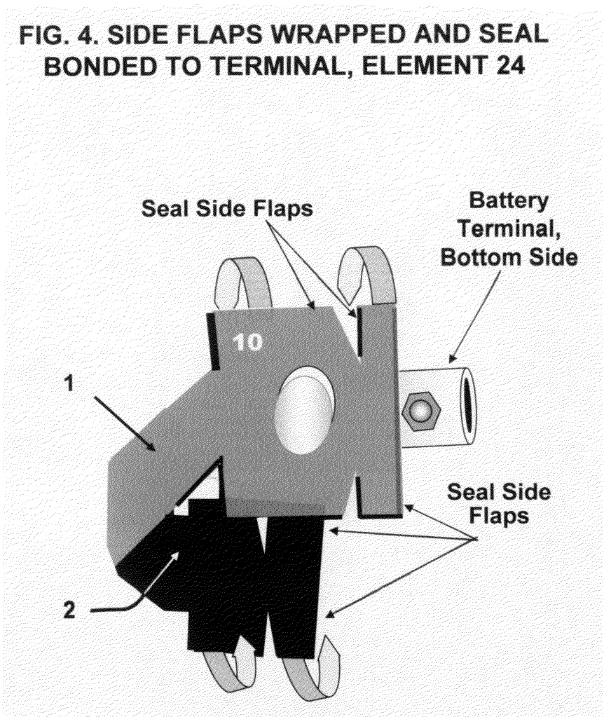

The process for seal positioning and deploy 22 insures that the seal is aligned with the longitudinal axis of the terminal and that the seal and terminal post-hole apertures also are aligned before deploying the seal. This element also includes the step that maintains proper seal orientation by the act of tacking the seal's adhesive sealant 2 to top and bottom surfaces of the terminal. FIG. 3 depicts the steps included in the seal positioning, alignment and deploy process. FIG. 3 shows the seal being positioned over and aligned with the terminal's underside post-hole aperture, and then being wrapped around the terminal top and bottom surfaces. After deploy, the user presses the seal firmly to bond the pressure-sensitive adhesive sealant 2 to these top and bottom terminal surfaces. FIG. 4 illustrates the process of stretching and overlapping the seal's side flaps around the terminal to secure the seal to the terminal, completing the seal-to-terminal bond element 24. Once stretched and overlapped, the seal's side flaps are pressed firmly to bond the pressure-sensitive adhesive sealant 2 to the terminal sides.

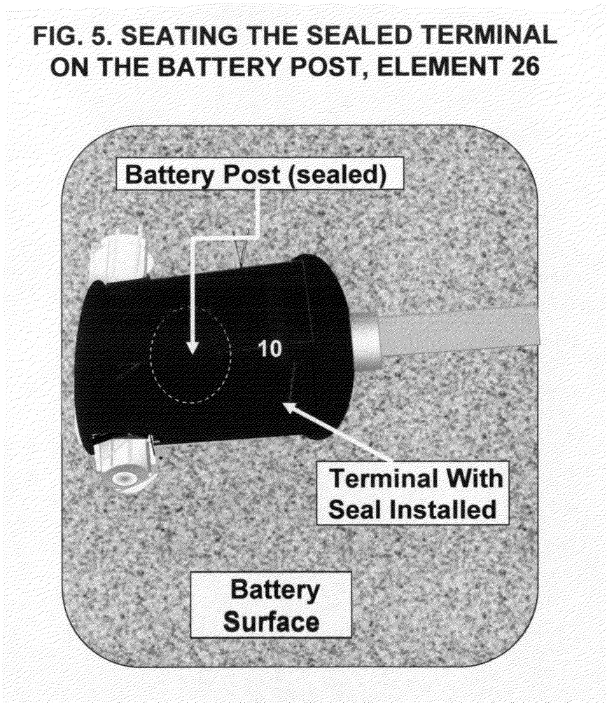

FIG. 5 is a top view illustrating the completing terminal seating element 26 wherein the terminal with installed seal is seated on the battery post and compressed against the battery plane. Access to the top of the battery post corrosion gateway is thusly blocked by the seal. Also, the act of seating the terminal on the battery post positions the sealant for delivery to the corrosion gateway at the base of the battery post.

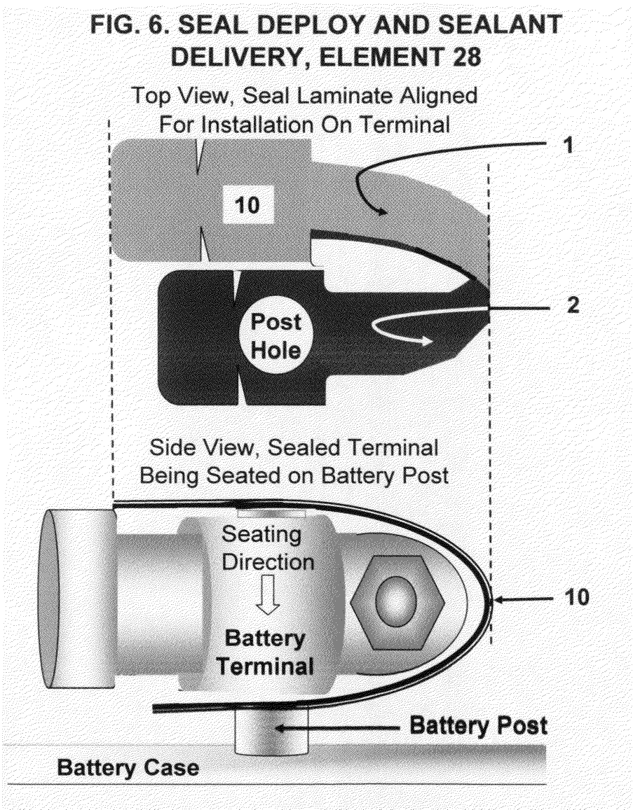

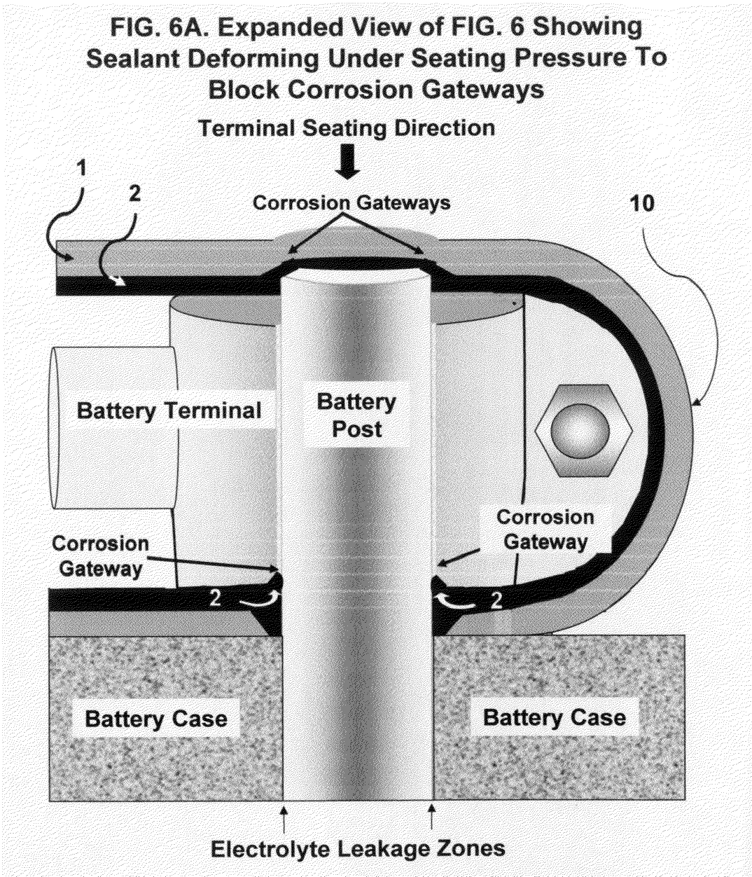

Completing sealant delivery 28 comprises the process to deploy the adhesive sealant 2 in a manner so as to deposit the sealant precisely and repeatably at corrosion gateway areas of the battery terminal. The FIG. 6 top and side views summarize the seal configuration attached to the terminal and, in addition, the seal seating process. The FIG. 6 top view shows the seal laminate configuration and the FIG. 6 side view depicts the seal laminate attached to the terminal ready for seating on the battery post. The block arrows shown in the side view illustrate the seating direction, as the user depresses the terminal against the battery surface. FIG. 6 demonstrates that the attached seal extends the axial length along the top side of the battery terminal, and thus is able to isolate upper battery post and terminal corrosion gateways. The seal laminate also extends along the underside of the terminal, such that when the terminal is fully ‘seated’ on the battery surface, underside corrosion gateways also are isolated from battery acid out gassing and other corrosive environments.

The expanded view of the FIG. 6 side view depicts the mechanics of completing sealant delivery 28 to the corrosion gateway where the battery post penetrates through the battery case. The expanded view of FIG. 6 illustrates how, once the battery terminal with seal deployed is seated on the battery post and depressed against the battery surface, the elastomeric sealant is able to migrate through the post-hole cutout to fill voids and depressions around the battery post and terminal juncture.

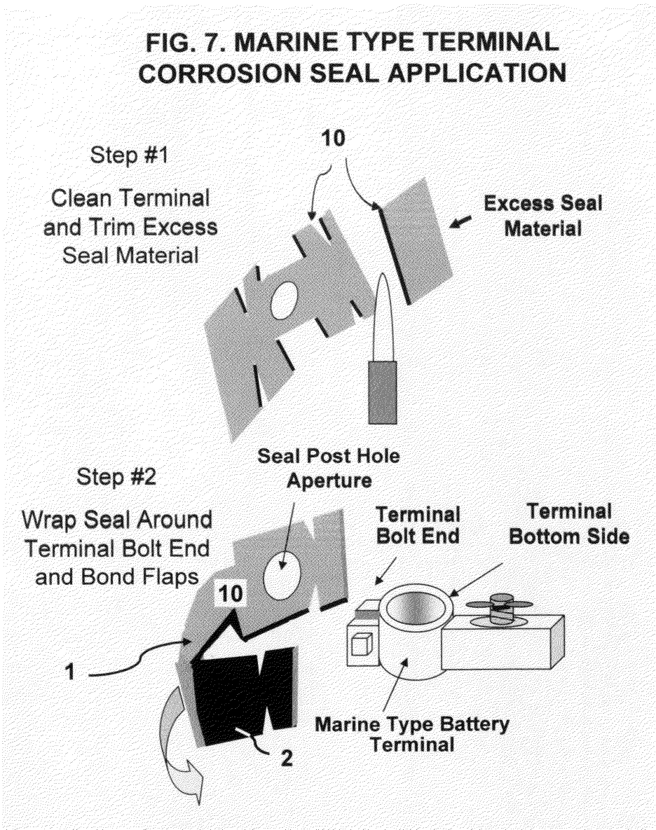

FIG. 7 is a perspective view illustrating the user-applied terminal sealant being applied to a ‘marine-type’ battery terminal.

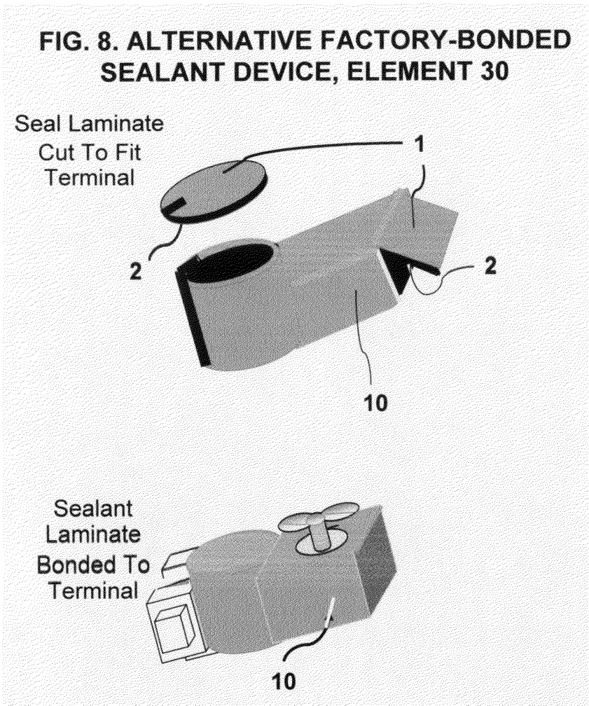

FIG. 8 is a perspective view illustrating the alternative approach wherein the battery terminal is fabricated with the sealant delivery device 30 for first-time use. For this alternative, the sealant device is bonded to the terminal when manufactured. An adhesive sealant 2 renewal kit comprising a butyl-based ‘touch-up’ or equivalent may be used as necessary to re-activate the inner sealant layer when a terminal when the factory-bonded seal must be removed and re-seated on the battery post.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method and apparatus for isolating battery terminals from corrosive elements for extending the functionality of battery-powered electrical systems, comprising:
means for preparing the seal laminate for deploy to the terminal;
means for positioning, aligning, and maintaining the seal laminate orientation relative to the terminal;
means for securing the seal to the terminal;
means for seating the sealant device on the battery; and
means for delivering the sealant to block electrically conductive surface gateways, simultaneously engaged to said means for seating the sealant device on the battery.

2. The method and apparatus for isolating battery terminals from corrosive elements in accordance with claim 1, wherein said means for preparing the seal laminate for deploy to the terminal comprises an adhesive seal free of liner, post-hole aperture removed from seal, and un-needed seal material removed for the user-installed device deploy preparation element.

3. The method and apparatus for isolating battery terminals from corrosive elements in accordance with claim 1, wherein said means for positioning, aligning, and maintaining the seal laminate orientation relative to the terminal comprises a seal and terminal with longitudinal axes aligned, seal and terminal with post-hole apertures aligned, seal wrapped around terminal bolt end, seal bonded to terminal top and bottom surfaces for seal positioning and deploy.

4. The method and apparatus for isolating battery terminals from corrosive elements in accordance with claim 1, wherein said means for securing the seal to the terminal comprises seal side flaps stretch-wrapped around terminal sides and seal side flaps bonded to terminal sides, completing the seal-to-terminal bond element.

5. The method and apparatus for isolating battery terminals from corrosive elements in accordance with claim 1, wherein said means for seating the sealant device on the battery comprises a terminal with attached seal seated on the battery post, terminal seal in contact with the battery plane, completing terminal seating element.

6. The method and apparatus for isolating battery terminals from corrosive elements in accordance with claim 1, wherein said means for delivering the sealant to block electrically conductive surface gateways comprises a terminal with attached seal depressed against the battery plane, sealant migration through post-hole aperture, moldable under user-applied pressure, terminal securing bolt tightened, completing sealant delivery.

7. A method and apparatus for isolating battery terminals from corrosive elements for extending the functionality of battery-powered electrical systems, comprising:
an adhesive seal free of liner, post-hole aperture removed from seal, un-needed seal material removed, comprising the user-installed device deploy preparation element for preparing the seal laminate for deploy to the terminal;
a seal and terminal with longitudinal axes aligned, seal and terminal with post-hole apertures aligned, seal wrapped around terminal bolt end, seal bonded to terminal top and bottom surfaces, for positioning, aligning, and maintaining the seal laminate orientation relative to the terminal;
the seal side flaps stretch-wrapped around terminal sides, seal side flaps bonded to terminal sides, completing the seal-to-terminal bond element for securing the seal to the terminal;
a terminal with seal attached seated on the battery post, terminal seal in contact with the battery plane, completing terminal seating element for seating the sealant device on the battery; and
a seal depressed against the battery plane, sealant migration through post-hole aperture, sealant moldable under user-applied pressure, terminal securing bolt tightened, completing sealant delivery to block electrically conductive surface gateways, simultaneously engaged to said completing terminal seating element.

8. The method and apparatus for isolating battery terminals from corrosive elements as recited in claim 7, further comprising:
a terminal with factory-installed seal outer layer, terminal with factory-installed sealant inner layer, available as an alternative battery sealant delivery device for first-time terminal use as a seal laminate installed on battery terminals at time of manufacture.
